(19) United States
(12) Patent Application Publication
(10) Pub. No.: US 2008/0172986 A1
(43) Pub. Date: Jul. 24, 2008

(54) Packing material production and bagging apparatus and methods for using same

(75) Inventors: Philip Neil Theurer, Glen Allen, VA (US); Jonathan Knaan, Kiryat-Ata (IL); Shiomo Nevo, Tel-Aviv (IL); Uzi Emanuel Aharony, Even-Yehuda (IL); Brian H. Bunnett, Highland Village, TX (US)

Correspondence Address: Martin D. Moynihan;PRTSI, Inc., P.O. Box 16446, Arlington, VA, 22215, US

(73) Assignee: FIPCO, Chicago, IL (US)

(21) Appl. No.: 11/826,773

(22) Filed: Jul. 18, 2007

Related U.S. Application Data
(63) Continuation-in-part of application No. 11/625,156, filed on Jan. 19, 2007.

(51) Int. Cl. B65B 61/00; B65B 1/30; G05B 19/00; B65B 43/08

(52) U.S. Cl. 53/284.7; 53/456; 53/493; 700/275

(57) ABSTRACT

A packing material production and bagging apparatus, comprising: a production and bagging section; a base; at least one sensor, configured to sense data regarding operation of the apparatus; and, a controller in communication with the at least one sensor programmed to automatically adapt operation of the apparatus in response to data received from the at least one sensor.

### RELATED APPLICATIONS

This application is a continuation-in-part of pending U.S. patent application Ser. No. 11/625,156 filed Jan. 19, 2007, the contents of which are incorporated herein by reference.

This application is also related to U.S. Provisional Patent Applications Nos. 60/736,801 on filed Nov. 15, 2005; 60/754,101 filed on Dec. 27, 2005 and 60/746,177 filed on May 2, 2006, the disclosures of which are herein incorporated by reference.

### FIELD OF THE INVENTION

The present invention relates to the packaging industry, for example by providing, in an exemplary embodiment of the invention, an adaptable apparatus for filling bags with packing material for use in packaging.

### BACKGROUND OF THE INVENTION

The packaging material industry has long been confronted with the problem of creating protective packaging for articles which come in various shapes and sizes and which should be packaged in as little time as is practicable. One common method of manufacturing packing material to counter such problems is reacting component chemicals on the spot to create a foam type cushioning material which is then packed with the article being protected. Often, the foam type cushioning material is first placed in a receptacle (e.g. bag) prior to packing the article.

U.S. Pat. No. 6,550,229, the disclosure of which is incorporated herein by reference, describes a device for sealing two plies of plastic film together generally includes an electrically conductive heating element and a rotatable support cylinder having an outer, circumferential surface, the cylinder being positioned in abutting relationship with the heating element and capable of rotating against the heating element, which is in fixed position, along a predetermined contact arc such that less than a complete circumference of the outer surface of the cylinder is in contact with the heating element.

U.S. Pat. No. 6,311,740, the disclosure of which is incorporated herein by reference, describes a mixing chamber assembly which has a reciprocating rod received within a mixing chamber of a mixing chamber member. The reciprocating rod is in a non-interference position with the mixing chamber over its entire length within the mixing chamber. The non-interference fit provides for continuous solvent flow about the exterior of the rod and interior of the wall defining the mixing chamber such that solvent drips out the discharge end of the mixing chamber and the rod is free to float or ride on a film of solvent. The ability for the rod to ride on a film of solvent over the entire portion received within the mixing chamber, allows for a much reduced reciprocating motive force requirement and a corresponding freedom to increase the mixing chamber volume. The mixing chamber member is preferably received within a dispenser housing such that it is free to shift behind a dispensing and a non-dispensing mode with a shuttle valve arranged between the housing and mixing chamber to seal off chemical precursors for forming polyurethane foam or the like from entering the mixing chamber when the mixing chamber member is in a non-dispensing mode.

U.S. Pat. No. 6,131,375, the disclosure of which is incorporated herein by reference, describes a protective foam cushion-making apparatus which dispenses reactive foam components into an interior space between two panels of plastic film to form protective foam cushions. The apparatus includes a supply of plastic film and a film a driving assembly, such as two pliable rollers. A foam component dispensing assembly is interposed between the film panels and injects reactive foam components into the interior space where they are mixed together to form a mass of expandable foam. The plastic film forms a flexible mixing chamber in the area between the two pliable rollers in which the reactive foam components are mixed together after they are dispensed from the foam dispensing assembly.

U.S. Pat. No. 5,679,208, the disclosure of which is incorporated herein by reference, describes a sealing and severing apparatus for sealing plastic bags formed in succession from stock plastic film material and then severing the sealed bags from one another. The bags are filled with a foamable composition while they are being formed so that when the formed and filled bags are placed in a container, the foamable composition fills the bag with foam to thereby produce a customized foam cushion for any objects in the container.

U.S. Pat. No. 5,139,151 and U.S. Pat. No. 5,027,583, the disclosures of which are incorporated herein by reference, describe methods of forming large-volume foam cushions for packaging purposes wherein each cushion comprises a closed bag formed from respective first and second superposed sheets of plastic material and filled with foam. Exemplary methods comprise folding at least one of the first and second sheets of plastic material along one side edge portion of the sheets inwardly to form a first longitudinally extending gusset therein; folding at least one of the first and second sheets of plastic material along the opposite side edge portion of the sheets inwardly to form a second longitudinally extending gusset therein; longitudinally sealing the outer side edges of the first and second sheets together to form a gusseted tube thereof; transversely sealing the first and second sheet together along a line generally perpendicular to the longitudinal side edge seals to thereby form a closed end of the gusseted tube; injecting a predetermined amount of a foamable composition into the closed end of the gusseted tube; and transversely sealing the gusseted tube along a line longitudinally spaced from the first transverse seal to thereby form a sealed bag containing the foamable composition, wherein as the foamable composition foams the gussets expand to produce a cushion of greater volume.

### SUMMARY OF THE INVENTION

An aspect of some exemplary embodiments of the invention relates to providing a software programmed controller for controlling and/or modifying and/or adapting the operation of a packing material production and bagging apparatus based on sensed and/or operator input information. In some exemplary embodiments of the invention, delay times and/or receptacle packing information is modified by an operator of the apparatus during operation by using the controller. Optionally, receptacle packing information includes delay times between filling each receptacle. Optionally, receptacle packing information includes a receptacle queue. Optionally, receptacle packing information includes standard receptacle type, size and/or filling data (such as fill percentage). In some exemplary embodiments of the invention, controller is operationally connected to a plurality of input devices. Optionally, an input device is an environmental sensor, such as at least one of a temperature, humidity or atmospheric pressure sensor. In some embodiments of the invention, sensed information from a sensor is used by the controller to adapt operation of the apparatus to the sensed information. In an exemplary embodiment of the invention, an operator activated control is an input device which is used for operating the packing material production and bagging apparatus. Optionally, the operator activated control is a delay button for delaying the filling of the next receptacle in the queue. In some exemplary embodiments of the invention, controller outputs receptacle packing information to a display.

An aspect of some embodiments of the invention relates to detection, notification and resolution of faults in a packing material production and bagging apparatus. In some exemplary embodiments of the invention, sensing devices operationally connected to a software programmed controller sense faulty operation of apparatus. In some embodiments of the invention, the controller notifies an operator of the apparatus of a fault. Optionally, exterior panels of the apparatus are opened by the controller upon the detection of a receptacle becoming stuck in the apparatus or other malfunction. Optionally, an audible alarm is activated by the controller upon the sensing of faulty operation of the apparatus. In some exemplary embodiments of the invention, the controller activates fault counter-measures, such as the use of a cleaning solvent when faulty operation of an applicator assembly is detected. In some embodiments of the invention, sensors for detecting movement of a transport system (described below) and/or receptacle alignment are provided. In some exemplary embodiments of the invention, at least one sensor is provided for determining the end of a receptacle material feed.

In some exemplary embodiments of the invention, the packing material production and bagging apparatus is provided with a dynamic receptacle transport system which decreases the likelihood of faulty operation of rollers within the system. In an exemplary embodiment of the invention, receptacle transport system improves reliability of roller operation by providing a “floating” motor configuration which eliminates the need for a special coupling between the motor and the shafts of the rollers transporting the receptacle material through the apparatus. In an embodiment of the invention, a motor in a “floating” configuration is mounted so that it can move in a plurality of degrees of freedom in the event that the roller to which it is attached is slightly misaligned (i.e. does not rotate precisely about its longitudinal axis). In some exemplary embodiments of the invention, a cut and seal roller is provided to the dynamic receptacle transport system for causing the forced release of the receptacle material after cutting and/or sealing has been performed, thereby reducing the likelihood of a jam.

In an exemplary embodiment of the invention, a heated system is provided to the packing material production and bagging apparatus for cutting and/or sealing receptacles. In an exemplary embodiment of the invention, a cutting and/or sealing element is a heated element which is comprised of a ribbed strip which adapted for cutting individual receptacles. In some exemplary embodiments of the invention, the heated element is used for sealing individual receptacles. Optionally, cutting and/or sealing is performed simultaneously on the receptacles using the heated element.

In an exemplary embodiment of the invention, a material to which the cut and/or sealed (e.g. melted) receptacle material does not stick is used to insulate the heated element from the receptacles being cut and/or sealed thereby preventing the receptacles from sticking to the heated element. Optionally, the material is Teflon®. In some exemplary embodiments of the invention, spring elements are provided to mechanically separate a receptacle from the heated element after the heated element has performed cutting and/or sealing on the receptacle.

In an exemplary embodiment of the invention, at least one spring is provided in operative connection to the ribbed, heated element for at least adjusting the resistance (for example, by using different k constant springs) exerted by the heated element on a cut and seal roller which serves to provide counter force to the heated element as it operates on the receptacle being cut and/or sealed. In an embodiment of the invention, the at least one spring acts as a shock absorber type spring. In some embodiments of the invention, at least one spring in operative connection with the heated element is used to overcome planar irregularity between the heated element and the cut and seal roller preventing an uneven cut and/or seal from being formed by the heated element.

In an exemplary embodiment of the invention, at least one leaf spring is used for removably mounting a cutting and sealing system which includes the cutting and/or sealing element on the apparatus. Optionally, the leaf spring is provided with a slot which mates with a protrusion adapted to fit within the slot located on the cutting and sealing system. In an embodiment of the invention, the leaf spring is used to bias the cutting and sealing system.

In some embodiments of the invention, the heated element is provided with a speed control system comprising a combination of at least one cam-follower and a motor speed control. In some exemplary embodiments of the invention, the power imparted to the heated element for heating is relative to the speed of operation of the apparatus wherein the faster the speed of operation the hotter the heated element is made and/or vice versa.

In some exemplary embodiments of the invention, heating is provided to tubes used for chemical transport in the apparatus in order to modify characteristics of the chemicals. For example, foaming speed and/or viscosity are characteristics that are modified by supplying heating to the chemicals.

In some exemplary embodiments of the invention, a software-programmed controller is used to control any of the above features as a result of data received from at least one sensor, for example controlling the heating of the tubes based on data received from an ambient temperature sensor.

An aspect of some exemplary embodiments of the invention relates to providing a method for producing and bagging packing material using a packing material production and bagging apparatus wherein at least one action of the method is adapted by a controller in response to data received from at least one sensor positioned on the apparatus.

An aspect of some exemplary embodiments of the invention relates to providing a method of displaying and using a receptacle manufacturing queue in a packing material production and bagging apparatus. In an embodiment of the invention, a controller is preprogrammed with receptacle information to create predefined receptacle profiles. Optionally, receptacle information is at least one of size and/or packing material fill percentage and/or a packing material material property. In an embodiment of the invention, receptacle information is displayed graphically to an operator by the controller on at least one display. Optionally, receptacle information is displayed in the form of a queue which shows the forthcoming receptacles in the production series and/or receptacle information regarding the receptacles. Optionally, the operator can alter one or more receptacles, by manually modifying receptacle information, in the production series. For example, the operator can input modification commands via the controller. Optionally the graphically displayed receptacle representation is in the form of a bar graph, wherein the height of the bars indicates receptacle size and the fill of the bars indicates the percentage of fill of the receptacles.

There is thus provided, in accordance with an exemplary embodiment of the invention, a packing material production and bagging apparatus, comprising: a packing material production and bagging section, wherein the section makes receptacles filled with packing material; at least one sensor, configured to sense data related to operation of said apparatus; and, a controller in communication with said at least one sensor programmed to automatically adapt operation of said apparatus in response to data received from said at least one sensor.

In an embodiment of the invention, the apparatus further comprises a display for displaying information to an operator of the apparatus.

In an embodiment of the invention, the apparatus further comprises a base on which the production and bagging section is adjustably mounted. In an embodiment of the invention, the apparatus further comprises a delay button for temporarily halting operation of the apparatus.

Optionally, the controller is programmed to with receptacle packing information. Optionally, receptacle packing information includes delay times between making of the receptacles. Optionally, receptacle packing information includes at least one of receptacle type, size and/or filling data. Optionally, the at least one sensor is an environmental sensor sensing at least one of temperature, humidity or atmospheric pressure. Optionally, the at least one sensor is adapted to sense faulty operation of the apparatus and communicate the faulty operation sensing to the controller. Optionally, the controller notifies an operator of the apparatus of sensed faulty operation. Optionally, the controller automatically activates at least one fault counter-measure upon sensed faulty operation. Optionally, at least one fault counter-measure is an alarm. Optionally, at least one fault counter-measure is automatically opening a door to the packing material production and bagging section to allow access to apparatus for service. Optionally, the packing material production and bagging section includes a cutting and sealing system adapted for cutting and sealing a material used for manufacturing the receptacles. Optionally, the cutting and sealing system is comprised of a cutting and sealing element. Optionally, the cutting and sealing element is heated. Optionally, the cutting and sealing element is comprised of a ribbed strip. Optionally, the cutting and sealing element is insulated from at least one other component of the apparatus by a non-stick material. Optionally, the cutting and sealing system is provided with at least one spring to buffer contact between the cutting and sealing system and at least one other component of the apparatus. Optionally, the controller modifies the operation of the cutting and sealing system based on sensed data from the at least one sensor.

In an embodiment of the invention, the apparatus further comprises a spring-loaded clamp adapted to clamp the material used for manufacturing the receptacles to cutting and sealing system.

In an embodiment of the invention, the apparatus further comprises a floating motor provided to the packing material production and bagging section.

In an embodiment of the invention, the apparatus further comprises an external door on which at least one component of the packing material production and bagging section is located wherein when the external door is open the at least one component does not obstruct access to an interior area of the packing material production and bagging section.

There is further provided in accordance with an exemplary embodiment of the invention, a method of producing and bagging packing material, comprising: sealing at least two edges of said receptacle material to define a bottom and at least one side of said receptacle; manufacturing packing material for injection into said receptacle; injecting said packing material into said receptacle; performing at least one of cutting or sealing a top of said receptacle; and, wherein at least one of said sealing, manufacturing, injecting, or cutting is adapted by a controller in response to data received from at least one sensor positioned on said apparatus. Optionally, at least one of sealing or cutting is adapted by the controller based on sensed speed of receptacle through said apparatus. Optionally, at least one of sealing or cutting is adapted by modifying the temperature used to perform the sealing or cutting. Optionally, manufacturing is adapted by the controller based on sensed ambient environmental conditions. Optionally, producing and bagging packing material is performed using predefined receptacle packing information. Optionally, the controller is pre-programmed with at least one of a delay time, receptacle size or fill percentage according to the predefined receptacle packing information.

There is further provided in accordance with an exemplary embodiment of the invention, a method of displaying a receptacle manufacturing queue in a packing material production and bagging apparatus, comprising: pre-programming a controller of the packing material production and bagging apparatus with receptacle packing information; receiving a command from an operator of the apparatus to produce receptacles with receptacle packing information; and, communicating from the controller to a display the receptacles to be produced, wherein the display presents a graphical representation of the receptacle queue which shows at least the size and the percentage of fill for the receptacles in the queue. Optionally, the graphical representation includes a hollow outline of each receptacle in the queue, indicating size and/or shape of each receptacle, and wherein the amount of the hollow outline that is filled in indicates percentage of fill for each receptacle.

### BRIEF DESCRIPTION OF THE DRAWINGS

Exemplary non-limiting embodiments of the invention are described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is an external, perspective view of a packing material production and bagging apparatus, in accordance with an exemplary embodiment of the invention;

FIG. 2 is an internal, perspective view of a packing material production and bagging apparatus, in accordance with an exemplary embodiment of the invention;

FIG. 3 is a detailed view of the packing material production and bagging section of the apparatus, in accordance with an exemplary embodiment of the invention;

FIG. 4 is an illustration showing a “floating” motor configuration, in accordance with an exemplary embodiment of the invention;

FIG. 5 is a perspective view of a cutting and/or sealing element, in accordance with an exemplary embodiment of the invention;

FIG. 6 is a detailed view of a gun system and packing material production and bagging apparatus, in accordance with an exemplary embodiment of the invention;

FIG. 7 is a detailed view of a base, in accordance with an exemplary embodiment of the invention;

FIG. 8 is a schematic of a controller, in accordance with an exemplary embodiment of the invention;

FIG. 9 is a flowchart of a general method of use for a packing material production and bagging apparatus, in accordance with an exemplary embodiment of the invention; and,

FIGS. 10A-D are a flowchart of a method of using a packing material production and bagging apparatus, in accordance with an exemplary embodiment of the invention.

### DESCRIPTION OF EXEMPLARY EMBODIMENTS

### Exemplary Packing Material Production and Bagging Apparatus

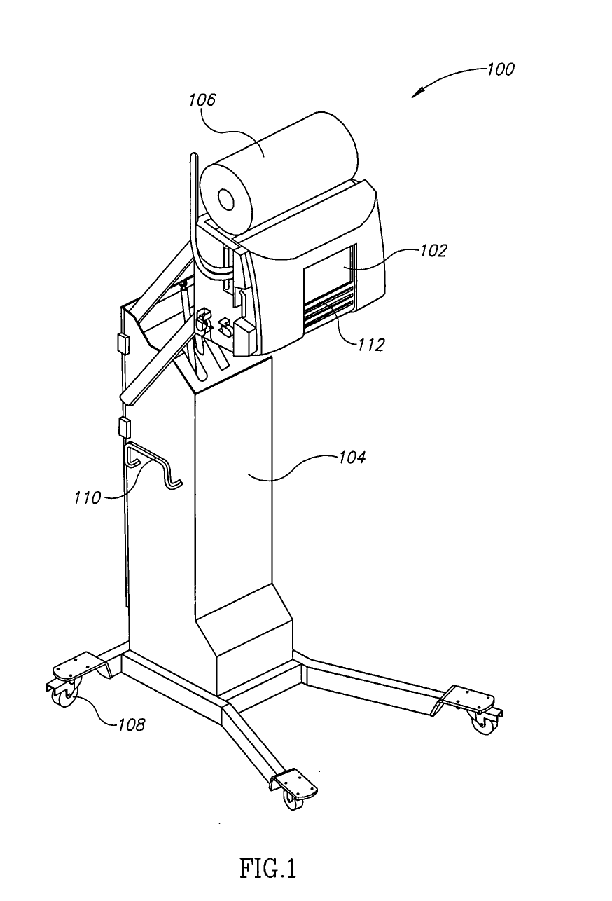

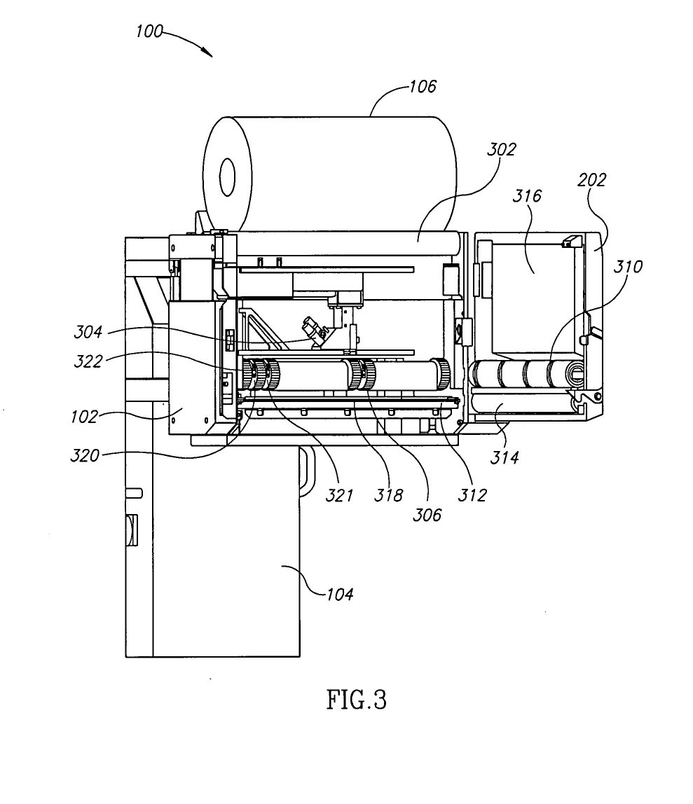

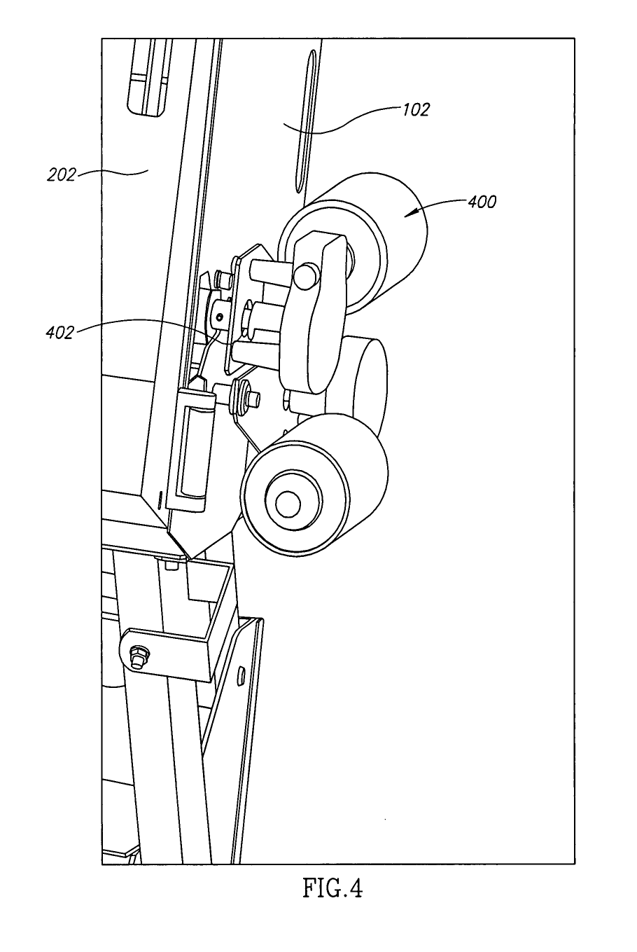

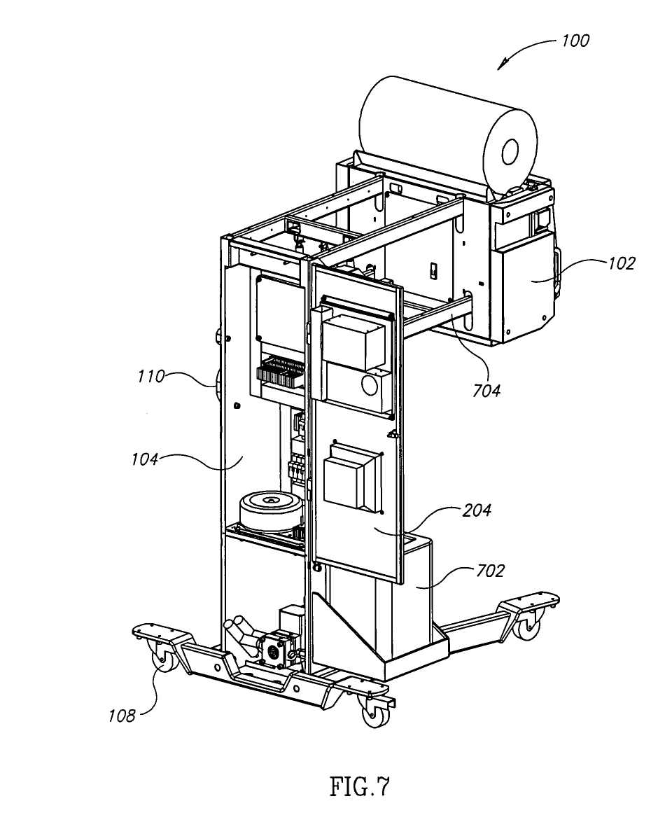

Referring to FIG. 1, an external, perspective view of a packing material production and bagging apparatus 100 is depicted, in accordance with an exemplary embodiment of the invention. In an exemplary embodiment of the invention, apparatus 100 is comprised of a production and bagging section 102 and a base 104. Production and bagging section 102 is described in more detail with respect to FIGS. 3 through 6 and base 104 is described in more detail with respect to FIG. 7, below. In an exemplary embodiment of the invention, apparatus 100 is used to manufacture packing material. Optionally, the packing material is created by mixing and/or reacting together at least two component chemicals. In some exemplary embodiments of the invention, the manufactured packing material is placed by apparatus 100 into receptacles, such as bags, for providing packaging for items to be transported. Receptacles are optionally made from receptacle material 106 located in proximity to production and bagging section 102, as described below with respect to FIG. 3. Optionally, receptacle material 106 is any heat sealable, water non-permeable material. Optionally, receptacle material 106 is high density polyethylene. In some embodiments of the invention, apparatus 100 is provided with at least one wheel 108 for mobility. Optionally, base 104 is provided with at least one operator graspable handle 110 for mobility. In some exemplary embodiments of the invention, a display 112 is provided to apparatus 100 to convey information to an operator or user of apparatus 100.

It should be understood that although apparatus 100 is often described in the context of production of packing material and bagging simultaneously, or nearly simultaneously, in some exemplary embodiments of the invention, bagging is not performed. In some exemplary embodiments of the invention, apparatus 100 is not used for producing the packing material but for bagging only.

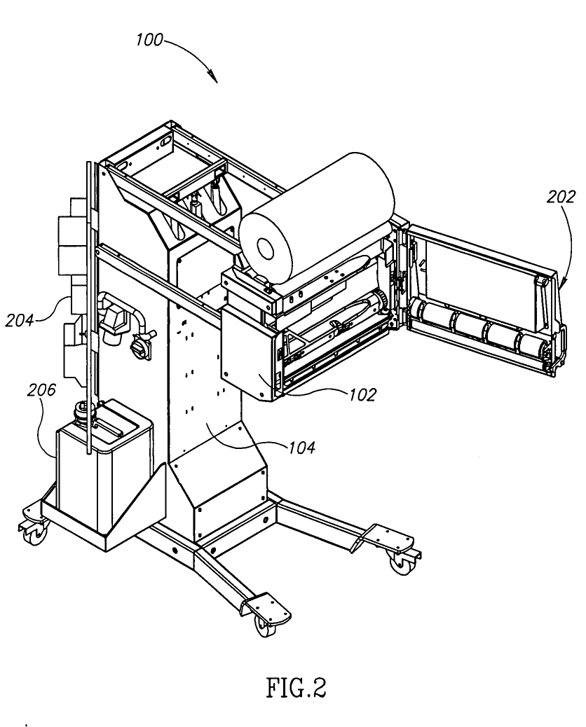

FIG. 2 shows an internal, perspective view of a packing material production and bagging apparatus 100, in accordance with an exemplary embodiment of the invention. Production and bagging section 102 is provided with an external door 202, in an exemplary embodiment of the invention, which provides access to the inside of production and bagging section 102, assisting an apparatus 100 operator with the use and maintenance of apparatus 100. Base 104 is depicted in more detail in FIG. 7, in accordance with an exemplary embodiment of the invention. Optionally, base 104 is provided with at least one access door 204 (shown open in FIGS. 2 and 7) for providing operator access to internal components of base 104. In some embodiments of the invention, a reservoir 206 is provided inside and/or outside base 104 for providing solvent and/or component chemicals to apparatus 100.

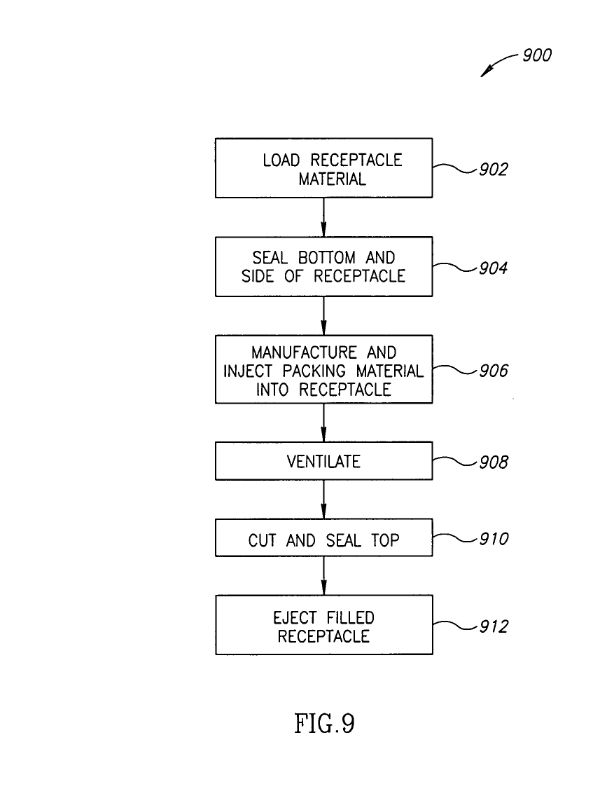

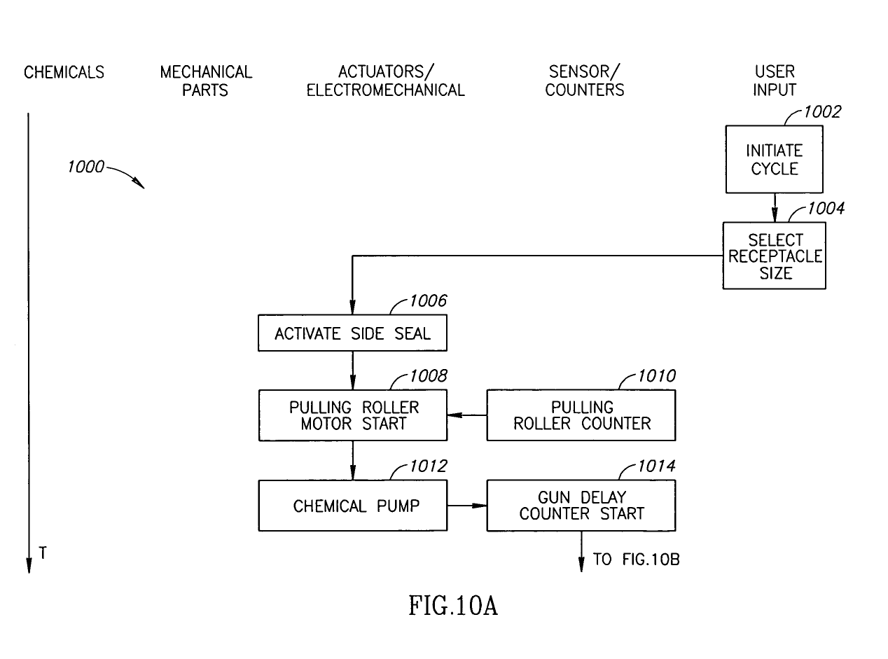

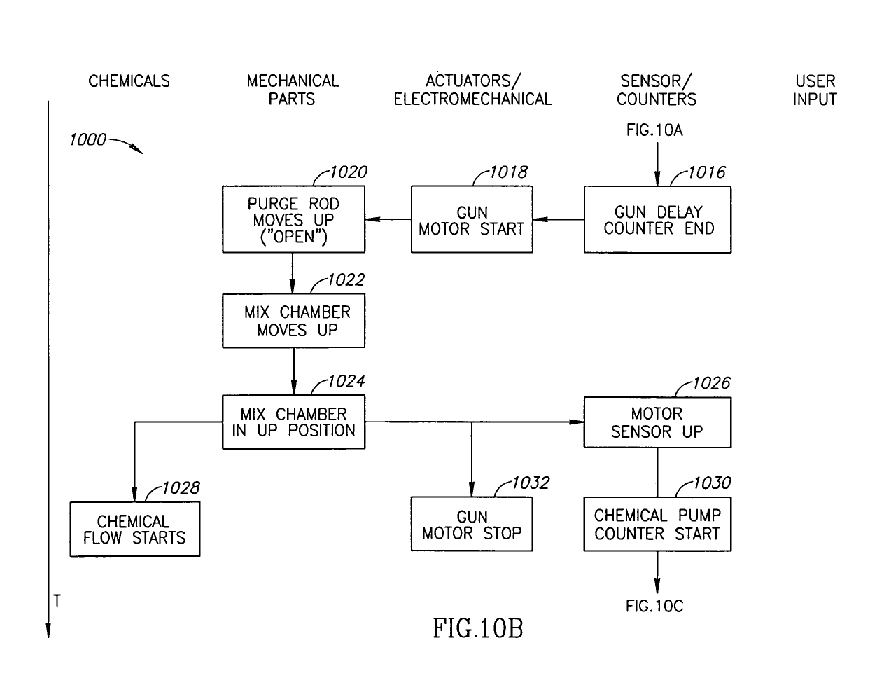

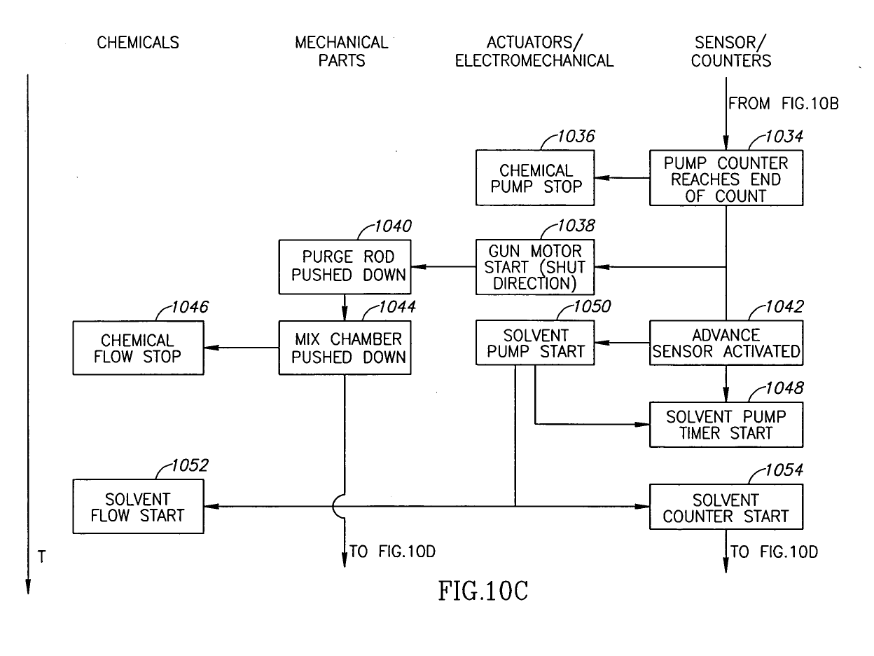

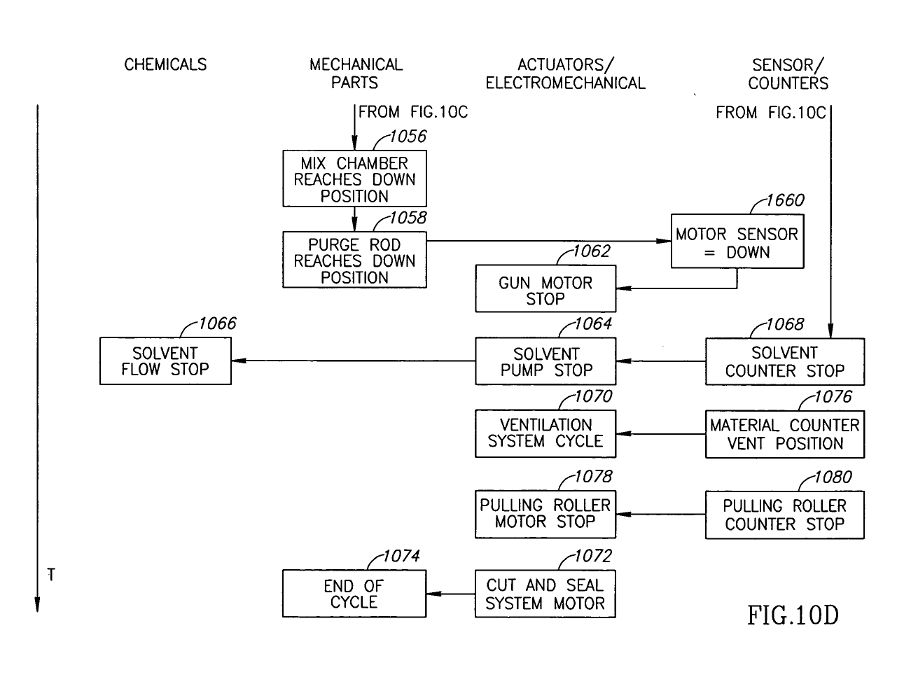

Referring to FIG. 3, a detailed, perspective view of production and bagging section 102 is shown in accordance with an exemplary embodiment of the invention. External door 202 is shown in an open condition revealing exemplary internal components and an exemplary internal configuration of production and bagging section 102. It should be understood that components are optionally added and/or removed depending on the application of use and/or needs of the operator. Briefly, in an exemplary mode of operation, receptacle material 106 is fed into production and bagging section 102 where components act upon receptacle material 106 to form receptacles, such as bags, for packing material. In an exemplary embodiment of the invention, the packing material is produced in production and bagging section 102, and optionally, within the receptacle itself. Upon completion of the production of an appropriate receptacle filled with the produced packing material, the receptacle is expelled from apparatus 100 by production and bagging section 102 and/or by gravity. Exemplary methods of use of apparatus 100 are described in more detail with respect to FIGS. 9, 10A and 10B below.

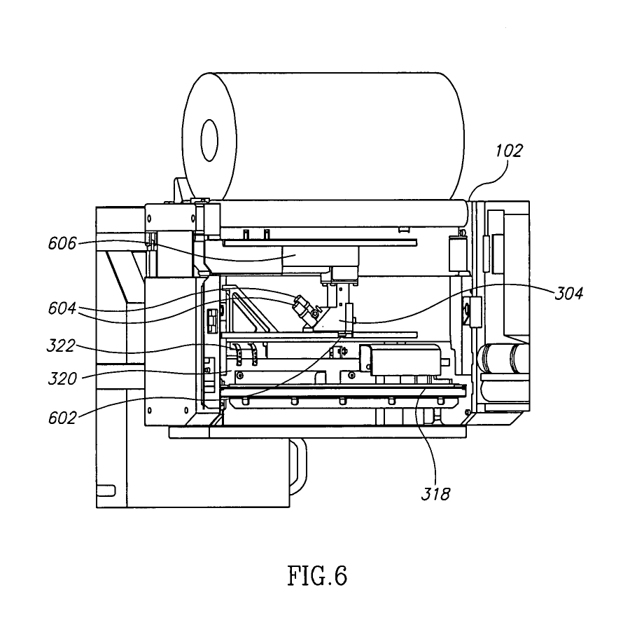

In an exemplary embodiment of the invention, at least one feeding roller 302 is provided to apparatus 100 for initially aligning receptacle material 106 and/or introducing receptacle material 106 into production and bagging section 102 for use by apparatus 100. In an exemplary embodiment of the invention, receptacle material 106 fed into section 102 by feeding roller 302, and is transported past and around a gun assembly 304, described in more detail with respect to FIG. 6, to at least one pulling roller 306. Pulling roller 306 pulls receptacle material 106 through machine to a cutting and sealing system 312, described below. In some embodiments of the invention, receptacle material 106 is stored and fed into apparatus 100 in a folded configuration, wherein the receptacle material has been folded in half around its longitudinal axis creating material which is closed on one end, where the fold is, and is open on the top, bottom and other longitudinal side. In an embodiment of the invention, receptacles are created by sealing the bottom, side and top as described herein.

In an exemplary embodiment of the invention, section 102 is provided with at least one sensor for determining when receptacle material 106 is running low and/or is depleted. For example for sensing a running low condition, at least one leaf spring connected to a switch can be provided between two feeding rollers 302 which cradle a roll of receptacle material 106. In an embodiment of the invention, as the roll of receptacle material 106 is exhausted it gradually decreases in overall diameter. This causes the roll to slowly sink into a gap between the feeding rollers 302 due to its decreased diameter. When receptacle material 106 runs “low”, the reduced diameter roll of receptacle material 106 exerts a load on the leaf spring, triggering the switch and signaling to a controller 800 (described in more detail below) that receptacle material 106 is running low. In some embodiments of the invention, the at least one leaf spring is positionable and/or is replaced to select the minimum amount of load exerted on it necessary to establish a connection between the spring and the electrical contact.

In an embodiment of the invention, a sensor for sensing receptacle material 106 depletion is comprised of at least one spring loaded contact mounted opposite an opposing contact. In an embodiment of the invention, receptacle material 106 passes between the spring loaded contact and the opposing contact during operation, preventing an electrical contact between the two contacts from being made. Upon receptacle material 106 depletion, spring loaded contact is urged against opposing contact, creating an electrical connection, optionally signaling to controller 800 that receptacle material has been depleted. In some embodiments of the invention, the at least one spring loaded contact is mounted on external door 202 and the opposing contact is mounted opposite the spring loaded contact in the interior of section 102 or could be, for example one of the rollers 302, 306 (the roller being conductive). In an embodiment of the invention, the sensor is comprised of two spring loaded contacts. Both contacts are mounted on external door 202 and the supporting roller that the film passes over is conductive. One contact is mounted out of the film's path and always contacts the roller. The other is mounted in the film path and contacts the roller when the film is exhausted, thereby triggering the sensor.

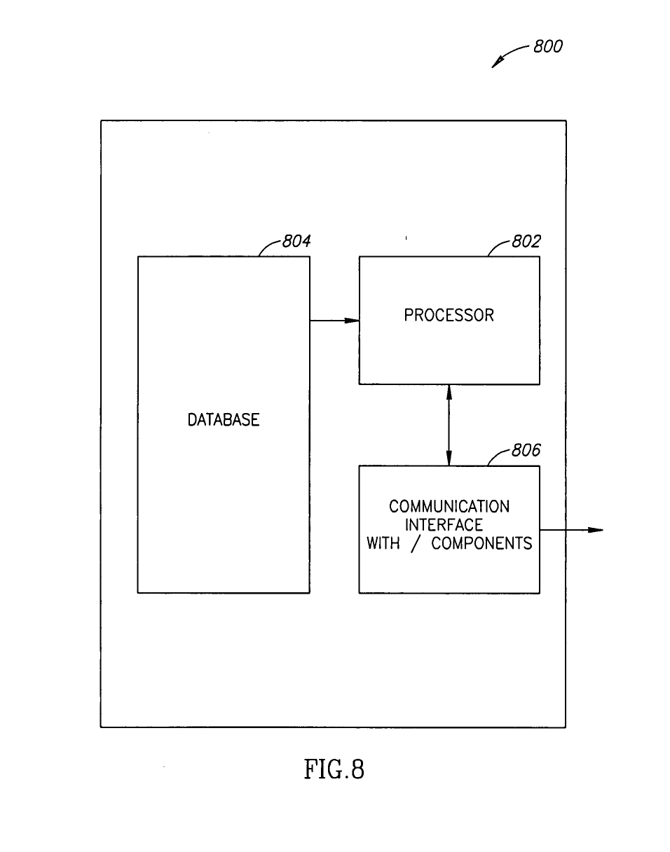

In an exemplary embodiment of the invention, pulling roller 306 operates to pull enough receptacle material 106 to create a receptacle of the size dictated by controller 800, depicted in FIG. 8. Optionally, pulling roller 306 is manually controlled by an operator. In an exemplary embodiment of the invention, lengths of receptacle material 106 passing through production and bagging section 102 are determined by using at least one encoder which counts revolutions of one or both of the rollers 302, 306. Using a count of the revolutions of a roller, it can be determined the total length of receptacle material 106 pulled through that roller. Optionally, the at least one encoder is positioned on a roller around which the receptacle material 106 is wrapped prior to use. Rollers 302, 306 are optionally constructed of a material which is at least slightly flexible and exhibits a high enough coefficient of friction on its surface to provide motion to receptacle material 106 without significant slippage. In some embodiments of the invention, only roller 306 is used to provide motion to receptacle material 106.

In some exemplary embodiments of the invention, a motor 400 for controlling at least one of rollers 302, 306 is dynamically located on a shaft 402 extending through a longitudinal axis of at least one of the rollers, as shown in FIG. 4. Typically, a coupling is used between shaft 400 and motor 400 to account for shaft rotational irregularities (not rotating precisely around the shaft's longitudinal axis), however, in an embodiment of the invention, motor 400 is provided with space around it for freedom of movement such that as shaft 402 rotates, any irregular rotation is translated to motor 400. It is believed that such a configuration reduces alignment problems between roller 306 and motor 400 in embodiments of the invention wherein roller 306 does not rotate precisely around its longitudinal axis, decreasing the likelihood of shaft 402 locking up and failing to rotate. Optionally, the motor 400 is an AC motor. Optionally, the motor 400 is a DC motor, for highly responsive motor control. In some embodiments of the invention, the motor is controlled by controller 800, for example for better speed control. Optionally, at least one of motor 400 and/or other motors described herein is a brushless motor.

In order to enhance control over receptacle material 106 passing through production and bagging section 102, a pulling support roller 310 is provided opposite pulling roller 306. In an exemplary embodiment of the invention, receptacle material 106 is passed by feeding roller 302 and subsequently between pulling roller 306 and pulling support roller 310. Optionally, a feeding support roller is provided opposite the feeding roller 302 to provide improved contact between the receptacle material 106 and the roller 302 pulling the material 106 into apparatus 100. In an embodiment of the invention, the feeding support roller and pulling support roller 310 are located on the inside of external door 202.

In an exemplary embodiment of the invention, various devices are provided to apparatus 100 for facilitating nominal operation of apparatus 100, for example to prevent inadvertent touching and/or sticking of receptacle material 106 to cutting and sealing system 312. A spring-loaded clamp is optionally used to clamp receptacle material 106 to cutting and sealing system 312 during the cutting and/or sealing of receptacles as they pass through section 102. It is believed that using a clamp to secure receptacle material 106 during the cutting and/or sealing process provides more effective cutting and/or sealing and also reduces the likelihood of receptacle material 106 sticking to the at least one cutting and/or sealing element after receptacle material 106 and the cutting and/or sealing element come into contact.

In some exemplary embodiments of the invention, devices are provided which reduce the likelihood or prevent receptacle material 106 from catching on parts of production and/or bagging section 102. For example, plate coverings 316 are used to provide a smooth protective surface over apparatus 100 components reducing the likelihood of receptacle material 106 becoming caught. In some embodiments of the invention, separators are positioned between components of apparatus 100 and receptacle material 106 as it transits through apparatus 100 to prevent electrostatic sticking of receptacle material 106 to components. Optionally, the separator elements are bent wire type spring elements and/or formed sheet metal strips.

As described above, receptacle material 106 width is approximately twice the length of feeding roller 302 and is loaded into apparatus 100 at feeding roller 302 in a folded-in-half condition, such that the width of receptacle material 106 is substantially the length of feeding roller 302 when folded. Using the view of FIG. 3 for reference, receptacle material is folded such that the right, vertical edge of receptacle material 106 is closed due to the fold and the left, vertical edge of receptacle material 106 is open. Prior to the commencement of any operations by apparatus 100 on receptacle material 106, the bottom edge is also open since no cutting and/or sealing has been performed on it by cutting and sealing system 312. Receptacle material 106 is fed into section 102 by feeding roller 302 and as it moves down through section 102, the folded material 106 is split so that one side of the folded material 106, a distal side, passes on a distal side of gun assembly 304 and a second side of the folded material 106, a proximal side, passes on a proximal side of gun assembly 304. In an exemplary embodiment of the invention, the splitting of receptacle material 106 is enabled by the left, vertical edge which is still open at this stage.

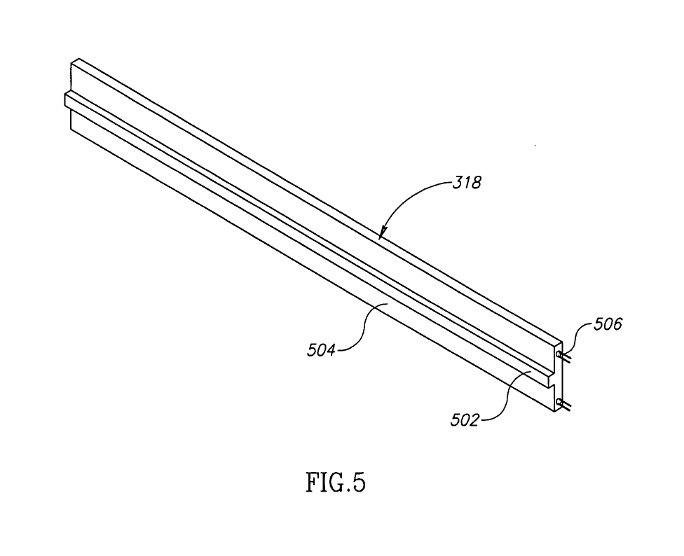

The cutting and sealing system 312 is provided to section 102 for assisting with the creation of receptacles, in some exemplary embodiments of the invention. In the configuration depicted in FIG. 3, cutting and sealing system 312 is located near a lower portion of production and bagging section 102. In an exemplary embodiment of the invention, cutting and sealing system 312 is comprised of a cutting and/or sealing element 318, described in more detail in FIG. 5. For example, the cutting and/or sealing element is comprised of a ribbed strip of metal, wherein the ribbing extends along the center of the strip along the longitudinal axis thereof. Optionally, there are more cutting and/or sealing elements depending on the requirements of use. Optionally, these cutting and/or sealing elements are heated. In some exemplary embodiments of the invention, at least one of the cutting and/or sealing elements is wire-like, thin and elongated. Optionally, the cutting and/or sealing elements are comprised of aluminum or other heat conductive material.

In an exemplary embodiment of the invention, cutting and/or sealing element 318 is used to cut (performing a cross-cutting function) and seal receptacle material 106, defining a bottom and/or a top of a receptacle. In an embodiment of the invention, an additional cutting and/or sealing element is optionally used to form an additional seal proximal to the bottom and/or or top of a receptacle. In an exemplary mode of operation, cutting and/or sealing element 318 cuts and seals the top of a receptacle while at the same time creates a sealed bottom of a new receptacle. Cutting and/or sealing element 318 is optionally used before, during and/or after the cutting and/or sealing process to provide an additional seal at or near the top and/or bottom of the receptacle.

In an exemplary embodiment of the invention, cutting and/or sealing element 318 is moveable into a cutting and/or sealing position when cutting and/or sealing is performed and into a standby position when cutting and/or sealing is not performed. In an exemplary embodiment of the invention, cutting and/or sealing element 318 is positioned on cutting and sealing system 312 and is provided with movement which causes cutting and/or sealing element 318 to transition between the standby position to the cutting and/or sealing position.

In an exemplary embodiment of the invention, a cut and seal roller 314 is provided to apparatus 100 opposite cutting and sealing system 312 to provide counter force to the at least one cutting and/or sealing element as it operates on receptacle material 106, which would be pressed between them at least temporarily. Optionally, cut and seal roller 314 is positioned on external door 202 such that receptacle material 106 passes between cut and seal roller 314 and cutting and sealing system 312 allowing easy loading of receptacle material 106 into apparatus 100 (by trapping material 106 between the interior surface of external door 202 and the components located in section 102). In an exemplary embodiment of the invention, cut and seal roller 314 rotates as receptacle material 106 passes through apparatus 100 so that consecutive cut and sealing operations are performed against a different part of the rotating surface area of cut and seal roller 314, thereby preserving life of the roller 314. Furthermore, rotation of cut and seal roller 314 causes a forced release of receptacle material 106 from roller 314 in some exemplary embodiments of the invention, reducing the likelihood of receptacle material 106 sticking to roller 314 after the cut and/or sealing process. In some embodiments of the invention, cut and seal roller 314 is motorized to rotate roller both for preserving life of roller 314 and for causing the forced release of receptacle material 106 after cutting and/or sealing has been performed.

In an exemplary embodiment of the invention, the forward movement of cutting and sealing system 312 against cut and seal roller 314 is buffered by providing at least one spring between cutting and sealing system 312 and the moving parts of apparatus 100 that provide movement to the cutting and sealing system 312. In some embodiments of the invention, the at least one spring is used to overcome planar irregularity between the cutting and/or sealing element 318 and the cut and seal roller 314 preventing an uneven cut and/or seal from being formed by the cutting and/or sealing element 318. For example, if one side of the cutting and/or sealing element 318 is closer to the cut and seal roller 314, when the cutting and/or sealing element 318 is advanced the closer side naturally comes into contact with the roller 314 first. Without the spring, forward movement of cutting and/or sealing element 318 towards the cut and seal roller 314 would halt, perhaps not yet cutting and/or sealing the part of the receptacle located near the farther side of the cutting and/or sealing element 318. Using the spring, however, even after the closer side contacts the cut and seal roller 314, forward movement can continue at least until the farther side of the cutting and/or sealing element 318 has had a chance to perform a cut and/or seal on the receptacle material 106. Optionally, the resistance exerted by the at least one spring is altered by using springs with different k constants.

As described above, cutting and sealing system 312 is used in some embodiments of the invention to cut and/or seal the tops and/or bottoms of receptacles. In an exemplary embodiment of the invention, a side sealing system is used to seal the left, vertical open side of receptacles as they are being made. Side sealing system includes a heated side sealing element 320, in accordance with an embodiment of the invention. Optionally, side sealing element 320 is a protrusion which is heat conductive. Again, using the view of FIG. 3 for reference, the side sealing element 320 is located on the left side of section 102 below gun assembly 304. In some exemplary embodiments of the invention, the open vertical edge and the location of the side sealing system are switched from left to right. Optionally, receptacle material 106 is not folded and exhibits an open edge on both the left and right and is sealed on both sides by side sealing system. In an exemplary embodiment of the invention, the side sealing element 320 is stationary and seals receptacle material 106 with heat as it moves by the side sealing element 320. In some embodiments of the invention, the side sealing element moves into a sealing position when receptacle material 106 is in motion through section 102 and moves into a standby position when material 106 is not moving. Optionally, side sealing element 320 is positioned on an arm 322 which is biased towards the external door 202, for example by a spring. Optionally, a side seal roller (not shown) is provided to external door 202 to provide counter pressure to side sealing element during the side sealing process.

As will be described in more detail below with respect to FIG. 8, a controller 800 is optionally in operative communication with at least one of cutting and sealing system 312, side sealing system, roller 314, and/or side seal roller. In an exemplary embodiment of the invention, heated cutting and/or sealing elements (e.g. cutting and/or sealing element 318 and/or side seal element 320 and/or a ventilation element 321) are heated to a temperature which is sufficient for cutting and/or sealing factoring in the speed at which receptacle material 106 is passing through section 102. Optionally, the temperature to which the cutting and/or sealing element 318 and side seal element 320 and/or ventilation element 321 are heated is determined by controller 800 depending on the type of material being used for receptacle material 106. In some embodiments of the invention, the speed at which cutting and/or sealing element 318 and side seal element 320 deploy into cutting and/or sealing position is determined by controller 800 factoring in the speed at which receptacle material 106 is passing through section 102. Optionally, the speed at which the cutting and/or sealing element 318 and side seal element 320 operate are determined by controller 800 depending on the type of material being used for receptacle material 106.

In some embodiments of the invention, ventilation element 321 is provided near side seal element 320, to create ventilation openings in the top of receptacles. Optionally, ventilation openings are created on only one side, proximal or distal, of the receptacle. In an exemplary embodiment of the invention, the ventilation element 321 uses anything capable of penetrating receptacle material 106 for creation of the ventilation openings. For example, a mechanical cutting element, such as a sharp blade, could be used. Optionally, a heated element is used to create the ventilation openings.

Referring to FIG. 5, a perspective view of cutting and/or sealing element 318 is shown, in accordance with an exemplary embodiment of the invention. In some embodiments of the invention, the cutting and sealing are performed by a single element. Optionally, cutting and/or sealing element 318 is heated to facilitate the cutting and/or sealing. Cutting and/or sealing element 318 is comprised generally of a strip which is comprised of a “flat” portion 504 on either side of a central rib 502, which extends the longitudinal length of cutting and/or sealing element 318. In an embodiment of the invention, central rib 502 is urged against receptacle material 106, which is trapped between central rib 502 and cut and seal roller 314, in order to provide cutting. The flat portions 504 of cutting and/or sealing element 318 use heat to melt the receptacle material 106 and form a seal on either side of the cut location. As described herein, the seal formed by the lower flat portion seals the top of the receptacle just manufactured, and the upper flat portion seals the bottom of the receptacle about to be manufactured. In some embodiments of the invention, connections 506 both mechanical and electrical are provided to cutting and/or sealing element 318 to provide heating energy and mechanical attachment to cutting and sealing system 312. It should be understood that in some embodiments of the invention rib 502 does not have to take the squarish shape shown, for example rib 302 could be other raised shapes like a semi-circle or a triangle.

An apparatus height adjustment mechanism is optionally provided to enable the adjustment of the height of section 102 off the floor. The apparatus height adjustment mechanism is described in more detail with respect to FIG. 7 below. In some embodiments of the invention, various power and control elements (e.g. printed circuit boards, controller 800) are located in section 102 and/or on the exterior of section 102.

Referring to FIG. 6, gun assembly 304 is more clearly shown in relation to section 102 of apparatus 100, in accordance with an exemplary embodiment of the invention. It should be understood that gun assembly 304 is optionally substantially comprised of any of the substance injecting apparatuses described in U.S. App. Ser. No. 60/754,101, the disclosure of which is incorporated herein by reference. For example, gun cartridge 602 is optionally similar to or the same as the cartridge designated with reference numeral “102” described in that application. In an exemplary embodiment of the invention, gun cartridge 602 is used to inject reacted chemicals, which will create a packing material, into a receptacle that has been formed for receiving the reacted chemicals. In some embodiments of the invention, apparatus 100 is provided with more than one gun assembly. For example, a handheld gun assembly is optionally used in conjunction with the section 102 mounted gun assembly 304, which can be used by an operator to fill receptacles which are too large to be produced in apparatus 100 and/or to manually add additional packing material to receptacles. In an exemplary embodiment of the invention, gun assembly 304 is provided with a casing which is configured to reduce the likelihood of receptacle material 106 wrinkling as it passes by gun assembly 304. For example, the surfaces of gun assembly 304 that come into contact with receptacle material 106 are designed to be flat and/or smooth. In some embodiments of the invention, the component chemicals of the packing material are reacted in the receptacle in addition to, or alternatively to, reacting them in gun cartridge 602. Chemical inlet ports 604 are provided to gun assembly 304 for introducing component chemicals into gun cartridge 602. In an exemplary embodiment of the invention, chemical inlet ports 604 are supplied with component chemicals from chemical reservoirs, described in more detail below with respect to FIG. 7.

Gun assembly 304 is optionally positioned on a moveable arm 606 that allows gun assembly 304 to pivot around a vertical axis (e.g. towards and/or away from external door 202) to allow easier operator access to other internal components of section 102. Optionally, moveable arm 606 can be locked in a closed position (typically assumed for apparatus 100 operation) and/or in an open position (typically assumed for maintenance). In some embodiments of the invention, apparatus 100 is operated with moveable arm 606 locked in the open position, and gun assembly 304 is used to fill pre-made bags which do not pass through apparatus 100. In some exemplary embodiments of the invention, cartridge 602 is easily removable and replaceable in the event of operational malfunction. In some embodiments of the invention, external door 202 is forward opening, allowing an operator of apparatus 100 easy access to the internal components of section 102 for maintenance and/or service. In some embodiments of the invention, some components of section 102 are located on external door 202 so that when external door 202 is opened, these components do not block access to the components located within section 102. For example, pulling support roller 310 and/or cut and seal roller 314 are located on external door 202 so that when door 202 is opened for service, loading and/or maintenance of apparatus, these rollers do not obstruct an operator's access to the interior of section 102. In embodiment of the invention, components mounted on door 202 are components which during operation are located on an opposite side of receptacle material 106 from the components which are not mounted on external door 202. This can be useful, for example, to assist with loading apparatus 100 with receptacle material 106 for use.Page: 19

FIG. 7 depicts base 104 of apparatus 100, in accordance with an exemplary embodiment of the invention. At least one reservoir is optionally located in and/or on base 104 for providing substances to production and bagging section 102, in an embodiment of the invention. For example, at least one reservoir located in and/or on base 104 can contain solvent used for cleaning gun assembly 304 before, during and/or after operation. Optionally, at least one reservoir is located in and/or on base 104 which contains a component chemical used for manufacturing packing material. An exemplary reservoir 702 is shown located on a shelf on the exterior of base 104. In some exemplary embodiments of the invention, reservoirs for solvent and/or component chemicals are not located in and/or on base 104, for example if their size is prohibitive for such location. In an exemplary embodiment of the invention, at least one pump is located in and/or on base 104. The pump is used for transporting component chemicals from the at least one reservoir to section 102 for injection by gun assembly 304 into receptacles. The pump is optionally similar to, or the same as, the type described in U.S. Apps. Ser. No. 60/736,801 and 60/754,101. In some exemplary embodiments of the invention, transportation of substances is conducted through heated tubing, which is intended to improve the flow characteristics of the substances.

In some exemplary embodiments of the invention, the apparatus height adjustment mechanism is in operative communication with controller 800, which automatically adjusts the height of section 102 off the floor, for example if an exceptionally large and/or long receptacle is produced which requires more space below section 102 than is typically available. Optionally, the height of section 102 is adjusted to accommodate a conveyor belt and/or an assembly line type apparatus, with packages located thereon, passing beneath section 102. In an exemplary embodiment of the invention, height adjustment arms 704 operatively connect section 102 to at least one motor located in base 104 which moves height adjustment arms 704. Optionally, the apparatus height adjustment mechanism includes at least one motor which is controlled by controller 800. Optionally, spring pistons are used to help provide movement to arms 704, reducing the force that the motor has to exert. In an embodiment of the invention, the apparatus height adjustment mechanism is manually operated and controlled. In an exemplary embodiment of the invention, the heated tubing which feeds substances from the reservoirs to section 102 is secured to at least one height adjustment arm 704 to reduce clutter around apparatus 100.

Base 104 is optionally provided with a tooling point near the pump for breaking loose the pump, which may become stuck to base 104 by leaked and reacted component chemicals. Optionally, base 104 is provided with at least one grasping handle 110 and at least one wheel 108 for provided mobility to apparatus 100.

### Exemplary Controller Configuration

Referring to FIG. 8, a schematic of controller 800 is shown in accordance with an exemplary embodiment of the invention. Controller 800 is optionally in operative communication with at least one of the various components of apparatus 100: display 112, cutting and sealing system 312, side sealing system, feeding roller 302, pulling roller 306, pulling support roller 310, cut and seal roller 314, side seal roller, at least one pump, at least one sensor, at least one reservoir, at least one heating element, gun assembly 304, the height adjustment mechanism, at least one motor, at least one operator operated control, and/or at least one fault indicator. The preceding list is not intended to be exhaustive, but to give examples only. In an exemplary embodiment of the invention, controller 800 is comprised of at least one of a processor 802, a database 804 and/or a communication interface 806, for communication between controller 800 and the various components of apparatus 100, examples of which are listed above.

In an exemplary embodiment of the invention, controller 800 communicates information regarding the operational status of apparatus 100 to an operator via display 112. For example, display 112 can provide information to the operator pertaining to receptacle sizes and/or the amount of packing material which will be used to fill the receptacles being produced. In some embodiments of the invention, receptacle packing information is pre-programmed into controller 800 prior to operation of apparatus 100. In some embodiments of the invention, receptacle packing information is stored as a receptacle profile such that commands to produce receptacles of like size, like fill percentage, material properties of the packing material (e.g. solid, liquid, something in between), etc. can be input into controller 800 by an operator using the predefined profile. Other examples of information could include not only information regarding the current receptacle being produced but at least one other receptacle which is to be produced subsequently. Optionally, icons (e.g. a hollow outline of the receptacle, a hollow outline of a bar graph) are used which show the size and/or shape and the percentage of fill (e.g. how much of the hollow is filled in) for the receptacles being produced by apparatus 100, for example in a receptacle queue.

In some exemplary embodiments of the invention, information regarding the operational status of apparatus 100 can also include speed of receptacle production, speed of receptacle filling, stage of the packing material production and bagging cycle (described in more detail with respect to FIGS. 9, 10A and 10B) and/or information related to various components of apparatus 100, such as the cutting and sealing system 312. Information is optionally stored in database 804. In some embodiments of the invention, operator operated controls are located on display 112, such as a touch screen display, which enable the operator to modify the operation of apparatus 100. For example, the operator can select a size of the receptacle to be produced and/or the amount of packing material used to fill the receptacle using display 112.

In an exemplary embodiment of the invention, controller 800 is programmed to adapt the operation of apparatus 100 based on at least one of a variety of factors, examples of factors including: data sensed by sensors, operational status of components, operator input, and/or a pre-programmed operation schedule. The following is list of examples of how controller 800 optionally adapts operation of apparatus 100 for these exemplary factors:

### Data Sensed by Sensors

A. Ambient Environmental Conditions—At least one sensor is optionally provided to apparatus 100 which senses ambient environmental conditions in the area surrounding apparatus 100, in accordance with an exemplary embodiment of the invention. Conditions optionally include temperature, atmospheric pressure, and/or humidity. Based on these sensed conditions, which can alter the reaction between the component chemicals, controller 800 optionally adapts operation by altering the temperature at which the heated tubing operates, changes the amount of component chemicals pumped, changes the speed at which the component chemicals are pumped and/or changes the amount of solvent used in order to produce desired reaction characteristics.
B. Gun Assembly Status—At least one sensor is provided to gun assembly 304 which can detect abnormal operation in an exemplary embodiment of the invention. For example, if the speed of cartridge 602 slows down below a certain nominal threshold during operation, controller 800 is optionally programmed to signal for a release of solvent or additional solvent for cleansing the cartridge 602 and/or gun assembly.
C. Receptacle Material Status—In an exemplary embodiment of the invention, at least one sensor is provided to section 102 which can detect if receptacle material 106 has been expended and needs refilling. In some exemplary embodiments of the invention, at least one sensor is provided to section 102 which can detect if receptacle material 106 becomes stuck and/or becomes unusable for its purpose as it passes through section 102. Controller 800 receives data from such sensors and signals to operator that more receptacle material is needed, automatically loads more receptacle material into apparatus 100 and/or slows or halts operation of apparatus 100 until more receptacle material has been provided to apparatus 100 or the faulty receptacle material condition has been corrected.

### Operational Status of Components

The following items are related to data sensing above in some embodiments of the invention since sensors may be used to detect receptacle material speed and/or cutting and/or sealing element temperatures, among others. In addition, the following items are optionally interrelated with one item being used by controller 800 to determine, in at least some part, the operation of another item. It should be noted that where an item is described as primary and other items variable based on that primary item, for example in the case of receptacle material speed below, any of the other items could be the primary instead.
A. Receptacle Material Speed—As described above, in some exemplary embodiments of the invention, receptacle material 106 is fed into apparatus 100 at feeding roller 302; receptacle material is then transported through apparatus by pulling roller 306. Depending on the sensed rotational speed of pulling roller 306, which essentially determines the speed of receptacle material 106 through section 102, controller 800 optionally adapts the speed of operation of cutting and sealing system 312 (by cutting/sealing faster or slower), side sealing system (by sealing faster or slower), gun assembly 304 (by injecting more or less reacted chemical into receptacle), and/or at least one pump (by transporting more or less component chemicals to be reacted) to provide for nominal operation of apparatus 100.
B. Cutting and/or Sealing Element Temperatures—In addition to the above modifications, controller 800 adapts the operating temperature of at least one of cutting and sealing system 312 and/or side sealing system, in accordance with an embodiment of the invention. For example, controller 800 could be programmed to raise the temperature of these components as the speed of receptacle material 106 through section 102 increases since cutting and/or sealing would need to be performed faster to match the faster speed.

### Operator Input

A. Delay Control—In an exemplary embodiment of the invention, apparatus 100 is provided with a delay control button which when triggered by an operator causes controller 800 to delay apparatus 100 operations for a period of time. Optionally, the delay period of time is preset. Optionally, the delay period of time persists as long as the operator holds the delay control button. In some embodiments of the invention, the delay control button is located on display 112. Optionally, delay control button is not located on the display, for example the delay control button is located in a foot pedal and is controlled by the foot of the operator.
B. Operator Input Delay—In some embodiments of the invention, an operator of apparatus 100 can manually input a delay time for at least the next receptacle. Controller 800 modifies the speed of various components of apparatus, for example pulling roller 306, to provide the requisite delay. Optionally, the delay time is input using display 112.
C. Individual Operator Profiles—Controller 800 is used to store individual operator profiles in some exemplary embodiments of the invention. Operator profiles are optionally stored in database 804. Depending on the selected operator profile, or even if no profile is selected (a default profile will be used by controller 800), controller 800 adapts apparatus 100 parameters such as height of section 102 (using height adjustment system), rate of receptacle production and filling and/or other parameters which may vary depending on an operator's individual preferences.

### Pre-programmed Schedule

A. Pre-programmed Production Schedule—In some embodiments of the invention, controller 800 stores at least one production schedule. Optionally, the production schedule includes receptacle size, packing material amount to be manufactured, amount of component chemicals to be pumped, speed of receptacle material through section 102, delay between receptacles, speed of cutting and sealing system 312, speed of side sealing system and/or other parameters related to producing receptacles and packing material for filling them. In some exemplary embodiments of the invention, these parameters are optionally changed by controller 800 from one receptacle to the next, depending on the pre-programmed schedule. Optionally, at least one production schedule is stored in database 804.

It should be understood that the preceding list is neither exhaustive of the factors that can be considered by controller 800 nor is it exhaustive of the ways controller 800 can adapt the operation of apparatus 100 using these factors.

In some embodiments of the invention, controller 800 is programmed so that it can make automatic adjustments to operational parameters of apparatus 100, such as those described herein, to maintain a desired level of operation. In some exemplary embodiments of the invention, controller 800 regulates apparatus 100 in embodiments where there is more than one gun assembly (for example, an additional handheld gun) allowing for operation of a specific one or, both of the gun assemblies. For example, when operating two gun assemblies from one pump, controller 800 may alternate which gun is fed by pump as activation of each gun assembly is detected by controller 800. In some exemplary embodiments of the invention, controller 800 modifies the volume of chemicals in an initial injection to counteract a “cold shot” effect, wherein more chemicals are needed to manufacture a set volume of packing material when using cold chemicals rather than heated chemicals (as is often the case when apparatus 100 is used for the first time before the tubing and/or chemicals heat up).

At least one fault sensor is provided to apparatus 100 in some embodiments of the invention. This at least one fault sensor is operatively connected to controller 800 which alerts an operator of apparatus 100 via an alarm. The alarm can be audible, visual or both. For example, a fault warning is depicted on display 112 in an exemplary embodiment of the invention. As described above, controller 800 also modifies operation of apparatus 100 depending on the fault detected For example, if controller 800 is notified with an alarm that receptacle material 106 is stuck in section 102, it might stop pulling roller 306 so that no more receptacle material is drawn into apparatus 100. In an exemplary embodiment of the invention, detected stuck receptacle material 106 causes controller 800 to open external door 202 so that an operator can attend to the problem. In some embodiments of the invention, apparatus operational logs are kept by controller 800 for fault analysis or other analytical purposes. Optionally, the logs are stored in database 804.

### Exemplary Method of Use of Packing Material Production and Bagging Apparatus

Referring to FIG. 9, a flowchart 900 showing a generalized method of use for apparatus 100 is shown, in accordance with an exemplary embodiment of the invention. Use of apparatus 100 is commenced by loading (902) with receptacle material 106 by placing it on or near section 102, in an embodiment of the invention. Loading (902), in an embodiment of the invention, includes advancing receptacle material 106 through section 102 into a position where it is in a position where a receptacle could be made. For example, external door 202 is opened and receptacle material is pulled down past feeding roller 302, gun assembly 304 (folded receptacle material 106 is split at gun assembly 304 so that a fold goes on each side of gun assembly 304) and pulling roller 306 by the operator of apparatus 100. External door 202 is then closed trapping receptacle material 106 between the interior surface of external door 202 and the components of section 102. After the initial cycle, the length of receptacle material 106 that is pulled by pulling roller 306 is determined by the size of receptacle desired. Optionally, the operator does not open external door 202 for loading and instead feeds receptacle material 106 into apparatus 100, past feeding roller 302 and gun assembly 304 (folded receptacle material 106 is split by gun assembly 304 so that a fold goes on each side of gun assembly 304) until the material 106 is engaged by pulling roller 306 which pulls as much receptacle material 106 as is necessary to create the receptacle size desired. Receptacle material 106 is then cut and sealed (904) by cutting and sealing system 312 and/or side sealing system which, in some embodiments of the invention, defines at least one side and/or the top and/or the bottom of a receptacle.

In an exemplary embodiment of the invention, packing material is made by reacting component chemicals together in a mixing chamber (found inside cartridge 602 in some embodiments of the invention) and then is injected (906) by gun assembly 304 into the receptacle. It should be understood at least one of the operational parameters of apparatus 100 are susceptible to adaptation by controller 800 depending on at least one of a number of factors, such as those described above with respect to FIG. 8. While controller-adapted operation of apparatus 100 is not described here, in an exemplary embodiment of the invention, any of the actions performed in the method portrayed in FIGS. 9, 10A and 10B are adapted by controller 800. In an embodiment of the invention, the receptacle is ventilated (908) by ventilation element 321. Optionally, the receptacle is ventilated near the top. Once a desired amount of packing material has been produced and injected into the receptacle, the receptacle is cut and sealed (910) on top by cutting and sealing system 312. Optionally, solvent used for cleaning gun assembly 304 is also enclosed within the receptacle, providing clean operation of apparatus 100. The final action in the packing material production and bagging cycle is ejecting (912) the receptacle from apparatus 100. Optionally, “ejecting” (912) occurs when the receptacle falls out of section 102 as a result of gravitational forces.

Referring to FIG. 10A, and continued on FIGS. 10B-D, a flowchart 1000 for a detailed method of use of apparatus 100 is shown, in accordance with an exemplary embodiment of the invention. It should be understood that the sequence of actions depicted in flowchart 1000 is by way of example only, is not completely inclusive, and that some actions can be performed before or after they appear in FIGS. 10A and 10B, or not at all, as long as the method of use stays in accordance with the general objective of producing packing material and/or filling receptacles with it. FIGS. 10A and 10B are constructed along two axes, the horizontal axis being divided into different operational categories including: chemicals, mechanical parts of gun assembly 304, motors/pumps, sensors/counters and operator inputs. The vertical axis is time starting at the top of the page moving towards the bottom of the page representing elapsed time. A “t” axis is shown on the left side of each Figure.

In an exemplary embodiment of the invention, an operator of apparatus 100 initiates (1002) a production and bagging cycle by, for example, pressing a start button. Optionally, the start button is located on display 112. In some embodiments of the invention, the operator manually selects (1004) a receptacle size. Optionally, the receptacle size is selected (1004) automatically by controller 800 as a result of a pre-programmed production schedule. At this stage, the operator and/or controller 800 have the opportunity to define parameters regarding the production cycle, for example overall speed of production, whether ventilation holes will be added to receptacle, delay period between receptacle production, and the like. In some embodiments of the invention, receptacle material 106 is fed into production and bagging section 102 of apparatus 100 at least until receptacle material 106 is engaged by pulling roller 306. As receptacle material 106 is pulled, side sealing system is activated (1006) to define at least a side of the selected (1004) receptacle (if this is the first receptacle of the roll a blank receptacle can be run using the described receptacle production method, minus the packing material manufacturing and filling, to create a bottom seal for the first bag of the actual run). Pulling roller 306 is activated (1008) to pull enough receptacle material 106 as is necessary to create a receptacle of the size selected (1004) by the operator or controller 800. As described above, at least one sensor is optionally used in combination with controller 800 to calculate (1010) the length of receptacle material 106 pulled into apparatus 100 by pulling roller 306. Optionally, the sensor counts revolutions of pulling roller 306.

The pump is started (1012) to transfer component chemicals from the reservoirs to gun assembly 304, in an embodiment of the invention. Because it is known that it will take some time for the component chemicals to transport from the reservoirs to gun assembly 304, operation of gun assembly 304 is delayed (1014) by a gun delay counter, where the delay is timed to coincide with the anticipated time of transit of the component chemicals. Once this anticipated time has passed, the gun delay counter releases (1016) the hold on gun assembly 304 operation and gun assembly 304 commences (1018) operation.

Gun assembly 304 is comprised of a number of moving parts, which are used to not only mix the component chemicals but also to inject them out of gun assembly 304 and keep gun assembly 304 in working order. While any suitable gun assembly could be used as gun assembly 304, the gun assembly as described in U.S. App. Ser. No. 60/754,101 is used in an exemplary embodiment of the invention. This gun assembly is comprised of at least a purge rod and a mixing chamber located within cartridge 602, in an exemplary embodiment of the invention. The purge rod is configured to travel coaxially within the mixing chamber, the mixing chamber defining a substantially cylindrical area in which component chemicals react to form the packing material. In an exemplary embodiment of the invention, gun assembly operation commences (1018) with the activation of a gun assembly motor and the subsequent movement (1020) of the purge rod by the motor towards an “open” position, where in the “open” position the component chemicals are allowed to enter the mixing chamber. In an exemplary embodiment of the invention, movement (1020) of the purge rod towards an open position causes mixing chamber to also transition (1022) to the open position. Once the mixing chamber has attained (1024) the open position, and at least one sensor detects (1026) this position has been achieved and communicates it to controller 800, the chemicals start to flow (1028) into the mixing chamber. In some embodiments, controller 800 signals for the start of at least one chemical pump counter (1030) which will help controller 800 control the amount of component chemicals that are delivered from the reservoirs to the mixing chamber of gun assembly 304. The gun motor is stopped (1032) while the chemicals flow into mixing chamber and react to form the packing material, in accordance with an embodiment of the invention.

Referring now to FIG. 10C, once the at least one chemical pump counter has reached (1034) the threshold established by controller 800 signaling that the desired amount of component chemical has been transported to the mixing chamber, the chemical pump is stopped (1036) by controller 800, in some embodiments of the invention. The gun motor is reversed (1038) causing the purge rod to reverse direction and travel downwards (1040). As the purge rod travels downwards (1040) or just prior to when the purge rod commences travel, in some embodiments of the invention, a purge rod advance sensor is activated (1042) which starts (1050) the solvent pump. Although the pump starts (1050) operation while the solvent can't actually flow, this primes the pressure in the solvent line so that the solvent flow can start at the instant the chemical flow stops. Once the mixing chamber starts movement downwards (1044), in an exemplary embodiment of the invention, the chemical flow stops (1046) as a result of the mixing chamber occluding the chemical inlets into the mixing chamber. Using the built up pressure, the solvent flows (1052) into gun assembly 304, commencing a process which substantially cleanses gun assembly 304 of reacted and component chemicals. In some exemplary embodiments of the invention, a solvent counter monitors (1054) the amount of solvent used for cleansing. The solvent pump runs for a period determined by a solvent pump timer which starts (1048) once the solvent pump starts (1050).

In an exemplary embodiment of the invention, the mix chamber continues its movement downwards until is reaches its ultimate down position (1056), followed by the purge rod reaching its ultimate down position (1058). In some embodiments of the invention, the purge rod travels past the tip of the mixing chamber in order to reduce the amount of reacted chemical that remains on the mixing chamber after the chemical reaction. At least one sensor detects (1060) the “closed” position has been achieved by gun assembly 304 and communicates this to controller 800 which in turn signals for the gun motor to stop (1062). The solvent pump is stopped (1064) after controller 800 stops the gun motor (1062), causing the solvent flow to stop (1066) in accordance with an exemplary embodiment of the invention. Controller 800 halts solvent counter (1068) when solvent pump is stopped (1064).

In an embodiment of the invention, a ventilation element 321 is activated (1070) to provide for at least one ventilation perforation in the receptacle before it is removed from apparatus 100. Optionally, this ventilation element 321 activation (1070) is a cycle, wherein element 321 switches on and then off again according to a pre-programmed plan. In an embodiment of the invention, a material counter/vent position sensor (1076) is used to sense the amount of receptacle material 106 that has passed by in the making of an individual receptacle so that ventilation element 321 can be activated (1070) at the right time to create ventilation in the receptacle at the desired location, for example near the top of the receptacle. Once a desired size of receptacle has been “pulled” through section 102, as tracked by the pulling roller counter, the pulling roller motor is stopped (1078), along with the pulling roller counter (1080). Optionally, material counter/vent position sensor is the same as the pulling roller counter. In an exemplary embodiment of the invention, the cutting and sealing system 312 motor is reactivated (1072) to cut and seal a top of the receptacle. This cutting and sealing defines the bottom of the next receptacle in some embodiments of the invention. The cycle is ended (1074) upon the ejection of the receptacle from apparatus 100. Optionally, the operator removes the receptacle manually from apparatus 100. In some embodiments of the invention, the receptacle falls out of apparatus 100 as a result of gravitational forces.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A packing material production and bagging apparatus, comprising:
a packing material production and bagging section, wherein the section makes receptacles filled with packing material;
at least one sensor, configured to sense data related to operation of said apparatus; and,
a controller in communication with said at least one sensor programmed to automatically adapt operation of said apparatus in response to data received from said at least one sensor.

2. An apparatus according to claim 1, further comprising a display for displaying information to an operator of the apparatus.

3. An apparatus according to claim 1, further comprising a base on which the production and bagging section is adjustably mounted.

4. An apparatus according to claim 1, further comprising a delay button for temporarily halting operation of the apparatus.

5. An apparatus according to claim 1, wherein the controller is programmed to with receptacle packing information.

6. An apparatus according to claim 5, wherein receptacle packing information includes delay times between making of the receptacles.

7. An apparatus according to claim 5, wherein receptacle packing information includes at least one of receptacle type, size and/or filling data.

8. An apparatus according to claim 5, wherein the at least one sensor is an environmental sensor sensing at least one of temperature, humidity or atmospheric pressure.

9. An apparatus according to claim 1, wherein the at least one sensor is adapted to sense faulty operation of the apparatus and communicate the faulty operation sensing to the controller.

10. An apparatus according to claim 9, wherein the controller notifies an operator of the apparatus of sensed faulty operation.

11. An apparatus according to claim 9, wherein the controller automatically activates at least one fault counter-measure upon sensed faulty operation.

12. An apparatus according to claim 11, wherein at least one fault counter-measure is an alarm.

13. An apparatus according to claim 11, wherein at least one fault counter-measure is automatically opening a door to the packing material production and bagging section to allow access to apparatus for service.

14. An apparatus according to claim 1, wherein the packing material production and bagging section includes a cutting and sealing system adapted for cutting and sealing a material used for manufacturing the receptacles.

15. An apparatus according to claim 14, wherein the cutting and sealing system is comprised of a cutting and sealing element.

16. An apparatus according to claim 15, wherein the cutting and sealing element is heated.

17. An apparatus according to claim 15, wherein the cutting and sealing element is comprised of a ribbed strip.

18. An apparatus according to claim 15, wherein the cutting and sealing element is insulated from at least one other component of the apparatus by a non-stick material.

19. An apparatus according to claim 14, wherein the cutting and sealing system is provided with at least one spring to buffer contact between the cutting and sealing system and at least one other component of the apparatus.

20. An apparatus according to claim 14, wherein the controller modifies the operation of the cutting and sealing system based on sensed data from the at least one sensor.

21. An apparatus according to claim 14, further comprising a spring-loaded clamp adapted to clamp the material used for manufacturing the receptacles to cutting and sealing system.

22. An apparatus according to claim 1, further comprising a floating motor provided to the packing material production and bagging section.

23. An apparatus according to claim 1, further comprising an external door on which at least one component of the packing material production and bagging section is located wherein when the external door is open the at least one component does not obstruct access to an interior area of the packing material production and bagging section.

24. A method of producing and bagging packing material, comprising:
sealing at least two edges of said receptacle material to define a bottom and at least one side of said receptacle;
manufacturing packing material for injection into said receptacle;
injecting said packing material into said receptacle;
performing at least one of cutting or sealing a top of said receptacle; and,
wherein at least one of said sealing, manufacturing, injecting, or cutting is adapted by a controller in response to data received from at least one sensor positioned on said apparatus.

25. A method according to claim 24, wherein at least one of sealing or cutting is adapted by the controller based on sensed speed of receptacle through said apparatus.

26. A method according to claim 25, wherein at least one of sealing or cutting is adapted by modifying the temperature used to perform the sealing or cutting.

27. A method according to claim 24, wherein manufacturing is adapted by the controller based on sensed ambient environmental conditions.

28. A method according to claim 24, wherein producing and bagging packing material is performed using predefined receptacle packing information.

29. A method according to claim 28, wherein the controller is pre-programmed with at least one of a delay time, receptacle size or fill percentage according to the predefined receptacle packing information.

30. A method of displaying and using a receptacle manufacturing queue in a packing material production and bagging apparatus, comprising:
pre-programming a controller of the packing material production and bagging apparatus with receptacle packing information;
receiving a command from an operator of the apparatus to produce receptacles with receptacle packing information; and,
communicating from the controller to a display the receptacles to be produced, wherein the display presents a graphical representation of the receptacle queue which shows at least the size and the percentage of fill for the receptacles in the queue.

31. A method according to claim 30, wherein the graphical representation includes a hollow outline of each receptacle in the queue, indicating size and/or shape of each receptacle, and wherein the amount of the hollow outline that is filled in indicates percentage of fill for each receptacle.
